(19) United States
(12) Patent Application Publication
(10) Pub. No.: US 2002/0174774 A1
(43) Pub. Date: Nov. 28, 2002

(54) Dust bag provided with means to enable operator of vacuum cleaner to detect easily a full load of dust bag

(76) Inventor: Peter Chen, Taichung Hsien (TW)

Correspondence Address: BROWDY AND NEIMARK, P.L.L.C., 624 Ninth Street, N.W., Washington, DC, 20001-5303, US

(21) Appl. No.: 09/864,224

(22) Filed: May 25, 2001

(51) Int. Cl. B01D 46/00

(52) U.S. Cl. 96/416

(57) ABSTRACT

A dust bag is designed for use in the vacuum cleaner and comprises a bag body of a hollow cylindrical construction. The bag body is provided in the interior with a dust-receiving space, and in one end with a dust admitting port in communication with a dust discharging port of the vacuum cleaner. The bag body is provided in the wall of the upper portion with a see-through window via which one can easily see if the dust-receiving space is fully loaded with dust.

### FIELD OF THE INVENTION

The present invention relates generally to a vacuum cleaner, and more particularly to a dust bag of the vacuum cleaner, which is provided with means to enable an operator of the vacuum cleaner to detect easily if the dust bag is fully loaded.

### BACKGROUND OF THE INVENTION

The conventional dust collecting machine is provided with a dust bag which is attached to a dust discharging port of the dust collecting machine. As the dust bag is fully loaded, the dust bag is detached from the dust discharging port of the dust collecting machine for disposal or reuse.

The conventional dust bag is defective in design in that the operator of the dust collecting machine is unable to tell if the dust bag of the dust collecting machine is fully loaded. A fully-loaded dust bag undermines the effectiveness of the dust collecting machine and can easily mess up the interior of the dust collecting machine, as well as the place where the dust collecting machine is operated.

### SUMMARY OF THE INVENTION

It is the primary objective of the present invention to provide a dust bag which is provided with means to enable the operator of a dust collecting machine to detect easily a full load of the dust bag, so as to enhance the efficiency of the dust collecting machine.

The foregoing objective of the present invention is attained by a dust bag comprising a bag body which is provided in the interior thereof with a receiving space, and at one end thereof with a dust admitting port. The dust is collected in the receiving space via the dust admitting port. The bag body is provided in the upper portion with a see-through window through which one can easily detect if the dust bag is fully loaded with dust.

The features and the advantages of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1 shows a schematic view of the preferred embodiment of the present invention in use along with a dust collecting machine.

FIG. 2 shows an exploded view of the preferred embodiment of the present invention.

FIG. 3 shows a perspective view of the preferred embodiment of the present invention in combination.

### DETAILED DESCRIPTION OF THE INVENTION

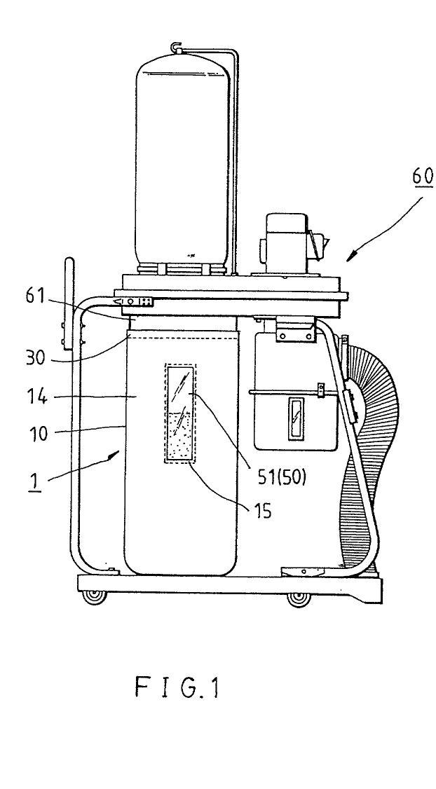

As shown in FIG. 1, a dust bag 1 of the preferred embodiment of the present invention is used to collect dust in conjunction with a dust collecting machine 60. The dust bag 1 is attached at one end with a dust discharging port 61 of the dust collecting machine 60.

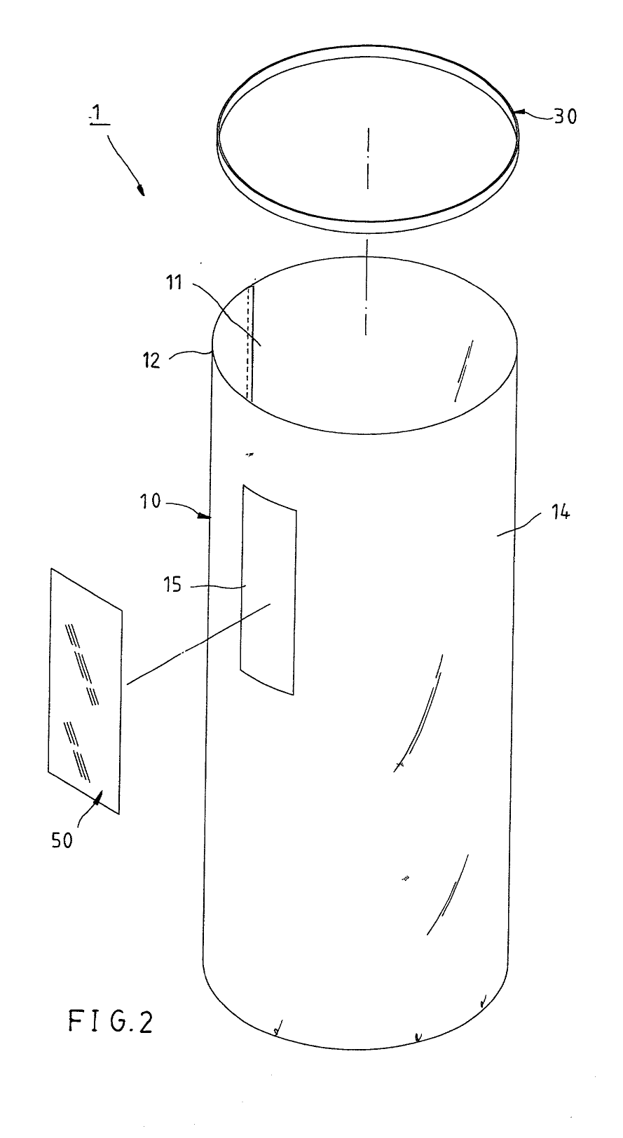

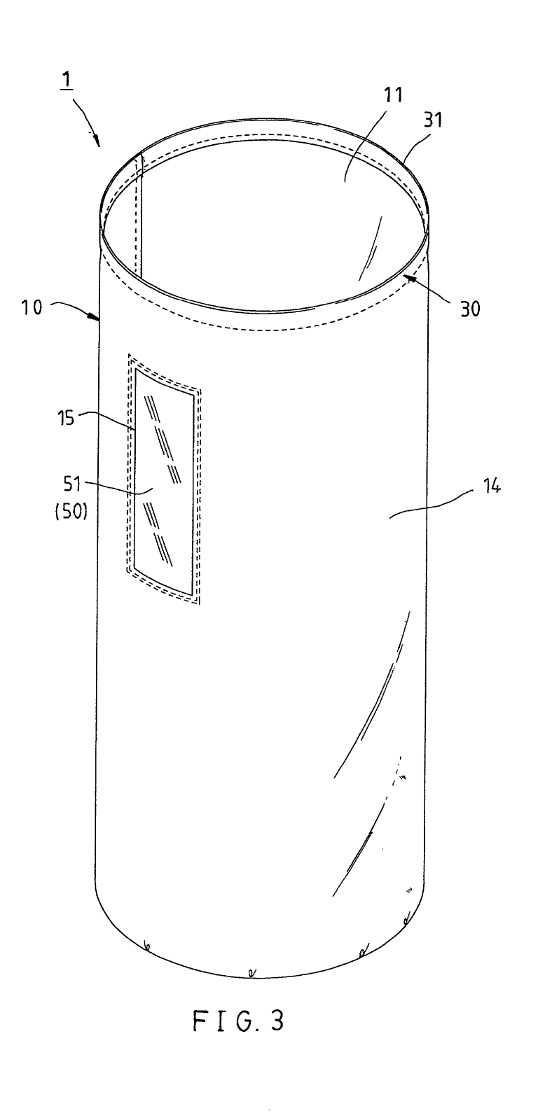

As shown in FIGS. 2 and 3, the dust bag 1 comprises a bag body 10, a fastening frame 30, and a transparent film 50.

The bag body 10 is of a hollow cylindrical construction and is provided in the interior with a dust-receiving space 11. The bag body 10 is provided at one end with a dust admitting port 12 via which the dust enters the dust-receiving space 11. The bag body 10 has other end which is closed. The bag body 10 is provided in the wall of an upper portion 14 with a window opening 15 of a rectangular construction.

The fastening frame 30 is of a circular construction and is fastened with the dust admitting port 12 by sewing. The fastening frame 30 is provided with a rigid rim 31 to facilitate the fastening and the unfastening of the dust bag 1 with the dust discharging port 61 of the dust collecting machine 60.

The transparent film 50 is of a soft plastic material. The transparent film 50 is fastened to the window opening 15 by sewing to form a see-through window 51 through which one can easily detect if the dust-receiving space 11 of the dust bag 1 of the present invention is fully loaded with dust, as illustrated in FIG. 1.

As a result, the machine operator can empty or replace in time the fully-loaded dust bag 1, so as to keep the machine operating efficiently, and to prevent the incident in which the interior of the machine 60 or the work place is messed up by the fully-loaded dust bag 1.

It must be noted here that the transparent film 50 may be fastened to the window opening 15 by an adhesive in place of sewing.

The embodiment of the present invention described above is to be regarded in all respects as being merely illustrative and not restrictive. Accordingly, the present invention may be embodied in other specific forms without deviating from the spirit thereof. The present invention is therefore to be limited only by the scopes of the following claims.

What is claimed is:

1. A dust bag for use in a vacuum cleaner for collecting dust, said dust bag comprising a bag body of a hollow cylindrical construction and provided in an interior thereof with a dust-receiving space, said bag body further provided at one end with a dust admitting port in communication with a dust discharging port of the vacuum cleaner; wherein said bag body is provided in the wall of an upper portion thereof with a see-through window enabling a person to detect a full load of said dust bag.

2. The dust bag as defined in claim 1, wherein said bag body is provided at said one end thereof with a fastening frame fastened therewith by sewing; wherein said bag body is fastened with the vacuum cleaner such that said fastening frame is detachably fastened with the dust discharging port of the vacuum cleaner.

3. The dust bag as defined in claim 2, wherein said fastening frame is of a circular construction.

4. The dust bag as defined in claim 1, wherein said see-through window is formed of a window opening, and a transparent film which is made of a soft plastic material and is fastened with said window opening.

5. The dust bag as defined in claim 4, wherein said transparent film is fastened with said window opening by sewing.

6. The dust bag as defined in claim 4, wherein said transparent film is fastened with said window opening by an adhesive.

7. The dust bag as defined in claim 1, wherein said see-through window is of a rectangular construction.
